(19) United States
(12) Patent Application Publication
(10) Pub. No.: US 2011/0111316 A1
(43) Pub. Date: May 12, 2011

(54) FUEL CARTRIDGE AND FUEL CELL SYSTEM

(75) Inventors: Yoshiaki Inoue, Aichi (JP); Kazuaki Fukushima, Kanagawa (JP); Atsushi Sato, Kanagawa (JP); Jusuke Shimura, Kanagawa (JP); Yuto Takagi, Kanagawa (JP)

(73) Assignee: SONY CORPORATION, Tokyo (JP)

(21) Appl. No.: 12/991,566

(22) PCT Filed: May 8, 2009
(86) PCT No.: PCT/JP2009/058695

§ 371 Date: Jan. 26, 2011

(30) Foreign Application Priority Data
May 16, 2008 (JP) 2008-129057

(51) Int. Cl. H01M 8/04

(52) U.S. Cl. 429/430; 429/447; 429/513

(57) ABSTRACT

A fuel cartridge (10) has a fuel container section (11), a fuel supplying port (12) for supplying liquid fuel reserved in the fuel container section (11) to a fuel cell body (30) therethrough, a primary cell (13) for supplying electric power for starting electric power generation of the fuel cell body (30), and an electrode configuration section (14) for supplying the electric power of the primary cell (13) to the fuel cell body (30). The fuel cell body (30) has a fuel accepting port (36) corresponding to the fuel supplying port (12), an electric contact section (37) corresponding to the electrode configuration section (14), a power generating device (31), a fuel supplying pump (33) for supplying liquid fuel from the fuel accepting port (36) to the power generating device (31), and a control device (32) for controlling so that the fuel supplying pump (33) is driven by the electric power of the primary cell (13). Even if electric power cannot be supplied from an auxiliary power supply of the fuel cell body, a fuel cell system can be started up simply and rapidly.

### TECHNICAL FIELD

The present invention relates to a fuel cartridge and a fuel cell system for supplying liquid fuel to a fuel cell body. More particularly, the present invention relates to a technique which makes it possible to supply not only liquid fuel with which a fuel cell body generates electric power but also electric power for starting the power generation from a fuel cartridge.

### BACKGROUND ART

In recent years, together with enhancement of functions or multi-functioning of portable electronic apparatus such as portable telephone sets, notebook type personal computers, digital cameras and camcorders, the power consumption of them has an increasing tendency. Therefore, attention is paid to a fuel cell with regard to which improvement in energy density and output power density can be expected as a power supply for such portable electronic apparatus.

In a fuel cell, fuel supplied to the anode side is oxidized while the air or oxygen is supplied to the cathode side to reduce the oxygen. And, chemical energy which the fuel has is converted efficiently into electric signal, and the electric energy is extracted and utilized. Therefore, if the fuel continues to be supplied to the fuel cell, then the fuel cell can continue to be used as a power supply even if it is not charged.

Among such fuel cells as described above, solid polymer type fuel cells (PEFC) which use a proton conductive polymer membrane as an electrolyte have the highest possibility that it may become a power supply for portable electronic apparatus. Among such polymer type fuel cells, a direct methanol fuel cell (DMFC) which uses methanol without modification as fuel supplies methanol of the fuel as aqueous solution of methanol of a low concentration or a high concentration to the anode side. And, the supplied methanol is oxidized into carbon dioxide by a catalyst layer on the anode side. Further, hydrogen ions generated thereupon move to the cathode side past a proton conductive polymer membrane sandwiched between the anode and the cathode and reacts with oxygen in a catalyst layer on the cathode side to produce water.

While, in the direct methanol fuel cell (DMFC), methanol which is liquid fuel is supplied to the anode side to generate electric power in this manner, to this end, auxiliaries such as a supply pump are provided in a fuel cell body. Further, methanol is supplied from a fuel cartridge which is, for example, removably mounted on the fuel cell body.

Here, the auxiliaries such as a fuel pump are driven by an auxiliary power supply provided in the fuel cell body. In particular, most fuel cell systems include a combination of an auxiliary power supply such as a lithium ion cell, a battery or a capacitor for the object of driving of auxiliaries such as a fuel pump, dealing with load variations to apparatus connected to the fuel cell body, power generation in a high efficiency, and so forth. And, during operation of the fuel cell system, part of the generated electric power is supplied to the auxiliary power supply to accumulate the electric power. Accordingly, when the fuel cell system is to be started up, the electric power accumulated in the auxiliary power supply is used to start up the fuel supply pump to supply methanol to the anode side.

However, the electric power accumulated in the auxiliary power supply is sometimes consumed excessively by high-load use of an apparatus connected to the fuel cell body. Further, the voltage of the auxiliary power supply sometimes drops as a result of self-discharge and so forth of the auxiliary power supply where the fuel cell system is not operated for a long period of time. And, if electric power cannot be extracted from the auxiliary power supply and driving of the supply pump is difficult, then the fuel cell system cannot be re-started.

Therefore, a technique is known wherein, upon startup, a terminal portion is taken out from the fuel cell body and is contacted with an electrode of an external cell so that the fuel cell system is started up using electric power of the external cell. In particular, if the electric power accumulated in the auxiliary power supply is insufficient and therefore the fuel power cell system cannot be started up using the electric power, then an external cell is connected so that the fuel cell system can be started up (refer to, for example, Patent Document 1).

### Prior Art Document

### Patent Document

Patent Document 1: Japanese Patent Laid-Open No. 2004-95189

### SUMMARY OF THE INVENTION

However, with the technique disclosed in Patent Document 1, in an emergency in which startup of the fuel cell system is difficult, an external cell must be assured. Therefore, there is a problem that, where an external cell is not prepared, where the size or the like of an external cell is not compatible with a terminal portion of the fuel cell body or in a like case, the fuel cell cannot be started up.

Further, with the technique disclosed in Patent Document 1, a notification that startup of the fuel cell system is difficult is issued, and a user is urged to mount an external cell. In short, after a notification is issued, an external cell is mounted, and thereafter, the fuel cell system is started up. Therefore, labor and time are required before the startup.

Accordingly, the subject to be solved by the present invention is to make it possible to start up a fuel cell system simply and rapidly even if electric power cannot be supplied from an auxiliary power supply of a fuel cell body.

The present invention solves the subject described above by the following solving means.

The invention according to claim 1 of the present invention is a fuel cartridge including a fuel container section formed for removable mounting on a fuel cell body and having liquid fuel, which is to be supplied to the fuel cell body, reserved therein, a fuel supplying port for supplying the liquid fuel reserved in the fuel container section to the fuel cell body therethrough, a cell for supplying electric power for starting power generation of the fuel cell body, and an electrode configuration section for supplying the electric power of the cell to the fuel cell body.

Meanwhile, the invention according to claim 3 of the present invention is a fuel cell system including a fuel cell body for generating electric power using liquid fuel, and a fuel cartridge formed for removable mounting on the fuel cell body for supplying liquid fuel to the fuel cell body, the fuel cartridge including a fuel container section having liquid fuel reserved therein, a fuel supplying port for supplying the liquid fuel reserved in the fuel container section to the fuel cell body therethrough, a cell for supplying electric power for starting power generation of the fuel cell body, and an electrode configuration section for supplying the electric power of the cell to the fuel cell body, the fuel cell body including a fuel accepting port corresponding to the fuel supplying port, an electric contact section corresponding to the electrode configuration section, a power generating device for starting electric power generation by supply of liquid fuel thereto, a fuel supplying device for supplying liquid fuel from the fuel accepting port to the power generating device, and a control device for controlling so that the fuel supplying device is driven by the electric power of the cell.

(Operation)

In the inventions described in claims 1 and 3 described above, liquid fuel for allowing the fuel cell body to generate electric power is reserved in the fuel cartridge. And, the fuel cartridge is formed for removable mounting on the fuel cell body. Further, the fuel cell cartridge has the cell for starting electric power generation of the fuel cell body. Therefore, if the fuel cartridge in which the liquid fuel is reserved is mounted on the fuel cell body, then the liquid fuel and the electric power necessary for electric power generation are supplied from the fuel cartridge.

With the invention described above, not only the liquid fuel for allowing the fuel cell body to generate electric power but also the electric power for starting electric power generation are supplied from the fuel cartridge. Therefore, even where the fuel cell body cannot supply electric power, only by mounting the fuel cartridge, in which the liquid fuel is reserved, on the fuel cell body, the fuel cell system can be started up simply and rapidly.

### BRIEF DESCRIPTION OF DRAWINGS

FIG. 1 is a perspective view showing a fuel cartridge of a first embodiment.

FIG. 2 is a concept diagram showing a fuel cell system of the present embodiment.

FIG. 3 is a flow chart illustrating a beginning of electric power generation by the fuel cell system of the present embodiment.

FIG. 4 is a perspective view showing a fuel cartridge of a second embodiment.

### MODE FOR CARRYING OUT THE INVENTION

In the following, embodiments of the present invention are described with reference to the drawings.

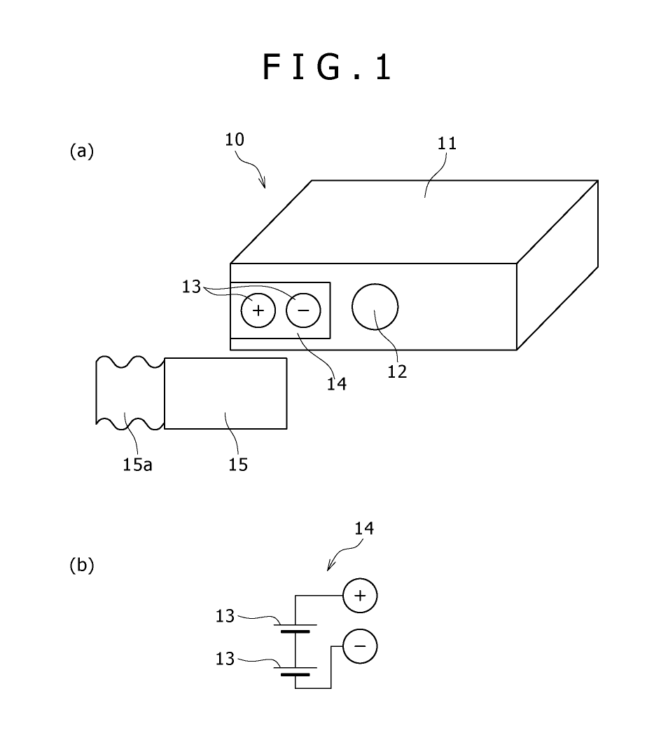

FIG. 1 is a perspective view showing a fuel cartridge 10 of a first embodiment.

As shown in (a) of FIG. 1, the fuel cartridge 10 of the first embodiment has a fuel container section 11, a fuel supplying port 12, a primary cell 13 (which corresponds to a cell in the present invention), a electrode configuration section 14, and a seal member 15 (which corresponds to a short-circuiting preventing member in the present invention).

The fuel container section 11 is a space having a high sealing performance for reserving methanol which is liquid fuel. And, an outer profile of the fuel container section 11 is formed in a parallelepiped which can be removably mounted on a fuel cell body 30 (not shown) hereinafter described. Further, a remaining amount sensor for detecting the remaining amount of the methanol is attached to the inside of the fuel container section 11. Therefore, if it is decided by the remaining amount sensor that the methanol in the fuel container section 11 is used up, then it is possible to remove the fuel cartridge 10 from the fuel cell body 30 and replace it with a new fuel cartridge 10 (in which methanol is reserved).

The fuel supplying port 12 is an exit for supplying methanol reserved in the fuel container section 11 therethrough and is formed on one side face of the fuel container section 11. And, an on-off valve is provided inside the fuel supplying port 12 so that the methanol may not flow out inadvertently. Therefore, upon transportation, storage, sales and so forth of the fuel cartridge 10, the methanol in the fuel container section 11 does not leak to the outside.

The primary cell 13 supplies electric power for starting power generation. And, in the present embodiment, a button-type manganese cell (electromotive force=1.5 V) is used as the primary cell 13. Further, as shown in (b) of FIG. 1, two primary cells 13 are disposed in series in the electrode configuration section 14 so that a predetermined voltage (approximately 3.0 V) may be obtained. It is to be noted that, as the primary cell 13, it is possible to use, in addition to the manganese cell, an alkali-manganese cell (electromotive force=1.5 V), a zinc-air cell (electromotive force=approximately 1.35 V), a silver oxide cell (electromotive force=approximately 1.55 V), a mercury oxide cell (electromotive force=approximately 1.35 V) and so forth.

The electrode configuration section 14 is a part serving as a terminal for supplying electric power of the primary cell 13 therethrough. In the present embodiment, two primary cells 13 are mounted in a predetermined direction such that the electrodes (+ and −) of them are connected in series inside the electrode configuration section 14. Further, if the two primary cells 13 are mounted in the predetermined direction on the electrode configuration section 14, then the electrodes (+ and −) exposed to the outside serve as they are as terminals of the electrode configuration section 14.

The seal member 15 prevents short-circuiting of the primary cells 13. In particular, the seal member 15 is pasted to the electrode configuration section 14 of the fuel cartridge 10 which is an unused article such that the primary cells 13 may not be transported, stored, sold or the like in a state in which the electrodes of the primary cells 13 are exposed. Therefore, if the fuel cartridge 10 is new, then not only sufficient methanol is reserved in the fuel container section 11, but also the primary cells 13 have sufficient electric power. It is to be noted that the seal member 15 is peeled off using a knob portion 15a thereof when the fuel cartridge 10 is to be used.

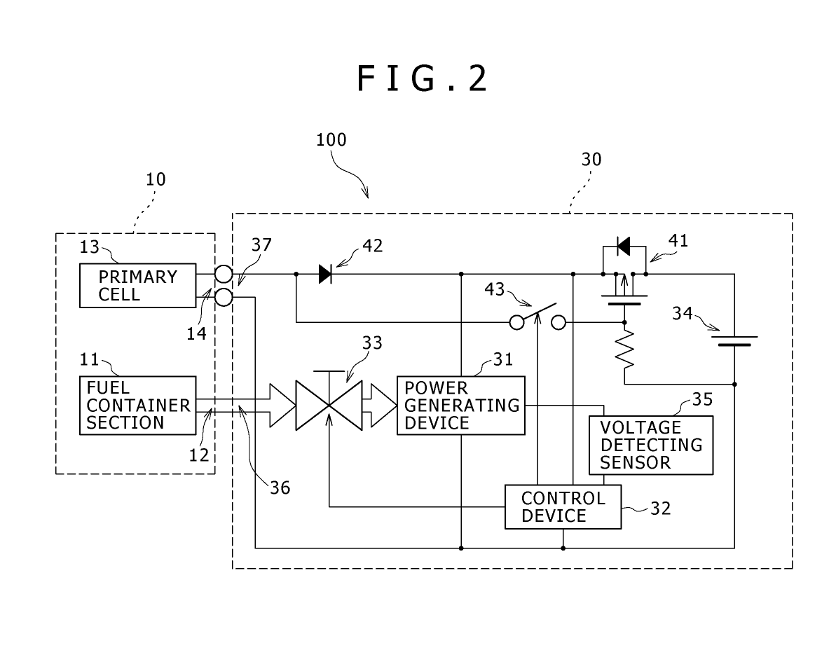

FIG. 2 is a concept diagram showing a fuel cell system 100 of the present embodiment.

The fuel cell system 100 of the present embodiment is a direct methanol fuel cell (DMFC) which uses methanol as fuel. And, as shown in FIG. 2, the fuel cell system 100 includes a fuel cartridge 10 and a fuel cell body 30 such that the methanol is supplied from the fuel cartridge 10 to the fuel cell body 30.

Further, the fuel cell body 30 has a power generating device 31, a control device 32, a fuel supplying pump 33 (which corresponds to a fuel supplying device in the present invention), an auxiliary cell 34 (which corresponds to a power accumulating device in the present invention), and a voltage detecting sensor 35 (which corresponds to a power generation detecting device in the present invention). Furthermore, the fuel cell body 30 has a fuel accepting port 36 from the fuel cartridge 10, and an electric contact section 37 to the fuel cartridge 10. Further, a diode 42, a switching element 41 and an on/off switch 43 are provided in a control circuit to which the control device 32 and so forth are connected.

The power generating device 31 generates electric power based on chemical energy which the methanol has. In particular, the power generating device 31 has a membrane-electrode joint body (MEA) wherein a fuel electrode on the anode side and an oxygen electrode on the cathode side are joined together on the opposite faces of a proton conductive polymer membrane. And, the fuel electrode includes an oxidation catalyst layer formed on the surface of a conductive porous substrate, and the oxygen electrode includes a reduction catalyst layer formed on the surface of a conductive porous substrate. It is to be noted that, as the conductive porous substrates, for example, a carbon sheet, carbon cloth and so forth are used. Further, the oxidation catalyst layer and the reduction catalyst layer are formed, for example, from a mixture of platinum or the like which is a catalyst and a proton conductor.

To the fuel electrode of such a membrane-electrode joining body (MEA) as described above, methanol is supplied, and to the oxygen electrode, oxygen or the air is supplied. And, the methanol supplied to the fuel electrode on the anode side is oxidized into carbon dioxide by the oxidation catalyst layer. Thereupon, hydrogen ions (protons: H+) from which electrons (e−) are separated are generated, and the generated hydrogen ions move to the cathode side past the proton conductive polymer electrolyte membrane while the electrons (e−) are extracted from the fuel electrode and supplied to a load. Furthermore, the electrons (e−) passing through the load and the hydrogen ions (protons: H+) passing through the proton conductive polymer electrolyte membrane react with oxygen in the reduction catalyst layer of the oxygen electrode to produce water.

In this manner, the power generating device 31 generates electric power by an electro-chemical reaction, and as a by-product other than the electric power, basically only water is produced. And, the electromotive force to be supplied to the load relies upon the amount of the methanol to be supplied to the fuel electrode of the power generating device 31. Therefore, electric power can be generated arbitrarily by controlling the fuel supplying pump 33 by means of the control device 32 to adjust the supplying amount of the methanol.

Here, the methanol is supplied from the fuel cartridge 10. In particular, the entire fuel cartridge 10 including the fuel container section 11 is formed for removable mounting on the fuel cell body 30. And, methanol is reserved in the fuel container section 11, and if the fuel cartridge 10 is mounted on the fuel cell body 30, then the fuel supplying port 12 and the fuel accepting port 36 are registered with each other and the on-off valve at the fuel supplying port 12 is opened. Therefore, the methanol in the fuel container section 11 is supplied to the fuel cell body 30 through the fuel accepting port 36.

Further, if the methanol in the fuel container section 11 of the fuel cartridge 10 mounted is used up, then the fuel cartridge 10 should be removed from the fuel cell body 30, and a new fuel cartridge 10 (in which methanol is reserved) should be mounted. Consequently, since the methanol is supplied into the fuel cell body 30, power generation by the power generating device 31 can be continued also after then.

Incidentally, although methanol is supplied to the power generating device 31 by the fuel supplying pump 33, the fuel supplying pump 33 is driven by electric power of the auxiliary cell 34. This auxiliary cell 34 is a secondary battery such as, for example, a lithium polymer battery, and part of electric power generated by the power generating device 31 is supplied to and accumulated into the auxiliary cell 34. Therefore, if the power generating device 31 starts power generation, then the fuel supplying pump 33 can be driven by the accumulated electric power of the auxiliary cell 34. Further, if the fuel supplying pump 33 is driven, then power generation by the power generating device 31 is permitted, and electric power is accumulated into the auxiliary cell 34. It is to be noted that presence or absence of power generation by the power generating device 31 is detected by the voltage detecting sensor 35.

However, if the load of an apparatus connected to the fuel cell body 30 is high, then the electric power to be supplied to the auxiliary cell 34 may be limited or the electric power accumulated in the auxiliary cell 34 may be consumed excessively. Further, if power generation of the power generating device 31 is not carried out for a long period of time, then the voltage of the auxiliary cell 34 may drop due to self-discharge of the auxiliary cell 34 and so forth. Therefore, when the fuel cell system 100 is to be started up, the electric power necessary to drive the fuel supplying pump 33 may not be extracted from the auxiliary cell 34. This makes power generation by the power generating device 31 impossible.

Therefore, the fuel cell system 100 of the present invention is configured such that, even if electric power of the auxiliary cell 34 is exhausted and the fuel supplying pump 33 cannot be driven by the auxiliary cell 34, it is possible to re-start the fuel cell system 100 normally to allow the power generating device 31 to start power generation. In particular, the fuel cartridge 10 has the primary cell 13 for supplying electric power for starting power generation. And, in a new fuel cartridge 10 (in which methanol is reserved), also the primary cell 13 has sufficient electric power. Therefore, if the fuel cartridge 10 is mounted on the fuel cell body 30, then not only the methanol reserved in the fuel container section 11 but also electric power of the primary cell 13 can be supplied.

This point is described in detail. Where electric power is accumulated sufficiently in the auxiliary cell 34 and the auxiliary cell 34 operates normally, the switching element 41 is in a conducting state (normal state). Therefore, electric power of the auxiliary cell 34 is supplied to the control device 32 through the control circuit, and the control device 32 controls the fuel supplying pump 33 to supply the methanol to the power generating device 31 to start power generation. However, if the electric power of the auxiliary cell 34 is exhausted, then supply of the electric power may be insufficient or may be impossible.

In such an instance, if the fuel cartridge 10 is mounted on the fuel cell body 30, then not only the fuel supplying port 12 and the fuel accepting port 36 are registered with each other, but the electrode configuration section 14 and the electric contact section 37 are registered with each other. And, although the fuel cartridge 10 is mounted (methanol exists), when the voltage detecting sensor 35 does not detect power generation of the power generating device 31, the control device 32 decides that the electric power of the auxiliary cell 34 is exhausted and controls the fuel supplying pump 33 to be driven by the electric power of the primary cell 13.

Accordingly, in the fuel cell system 100 of the present embodiment, even if the auxiliary cell 34 fails to drive the fuel supplying pump 33, the fuel supplying pump 33 is driven by the primary cell 13 of the fuel cartridge 10. In other words, if a new fuel cartridge 10 (in which methanol is reserved) is mounted on the fuel cell body 30, then not only the methanol which is liquid fluid but also electric power of the fuel supplying pump 33 for supplying the methanol can be assured simultaneously. As a result, the methanol is supplied to the power generating device 31 and the power generating device 31 starts power generation. It is to be noted that the electric power of the primary cell 13 is sufficient to operate the fuel supplying pump 33 for a driving period of time in which a pump delivery amount necessary to fill the fuel supplying pump 33 and a pipe system to the power generating device 31 with methanol and a necessary supplying amount of methanol before the fuel cell system 100 is placed into a steadily operating state can be satisfied.

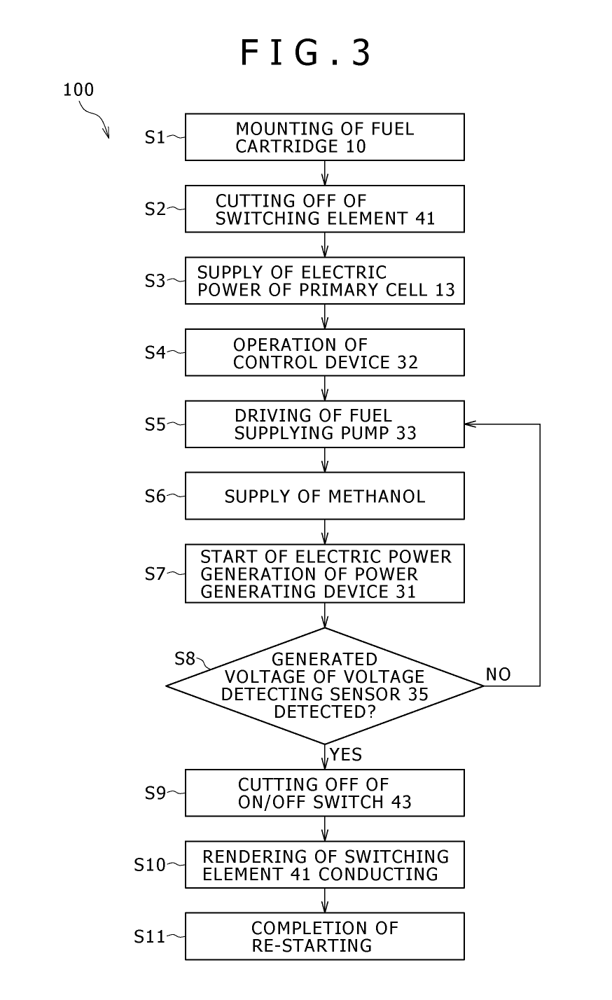

FIG. 3 is a flow chart illustrating a beginning of electric power generation by the fuel cell system 100 of the present embodiment.

In order to start electric power generation of the fuel cell system 100, a new fuel cartridge 10 is mounted on the fuel cell body 30 (refer to FIG. 2) at first step S1 shown in FIG. 3. Consequently, the primary cell 13 of the fuel cartridge 10 is connected to the fuel cell body 30 through the electrode configuration section 14 and the electric contact section 37 as shown in FIG. 2. Therefore, the positive electrode of the primary cell 13 is connected to the diode 42, and electric power is supplied to the fuel cell body 30. It is to be noted that the diode 42 is inserted in order to prevent electric power generated by the power generating device 31 or electric power of the auxiliary cell 34 from flowing to the primary cell 13.

If the fuel cartridge 10 is mounted at step S1 shown in FIG. 3, then the switching element 41 is cut off at next step S2. In particular, the switching element 41 is formed from a field effect transistor (FET) as shown in FIG. 2, and electric current between the source and the drain is controlled by a principle of gating a flow of electrons or holes by an electric field of a channel when a voltage is applied to the gate electrode. And, the on/off switch 43 is normally closed and exhibits a conducting state. Therefore, when the fuel cartridge 10 is mounted, the voltage of the primary cell 13 acts upon the switching element 41 from the anode side of the diode 42 to place the switching element 41 into a cut-off state.

If the switching element 41 is cut off in this manner, then the positive electrode of the auxiliary cell 34 is cut off from the control device 32. Therefore, at next step S3 shown in FIG. 3, electric power is supplied from the positive electrode of the primary cell 13 to the control device 32 through the diode 42 shown in FIG. 2.

Further, when the supply of electric power from the primary cell 13 is started, the control device 32 is rendered operative at step S4 shown in FIG. 3. Then, the control device 32 controls so that the fuel supplying pump 33 is driven at subsequent step S5. In particular, when the fuel supplying pump 33 is placed into a driven state by electric power of the primary cell 13 (electromotive force of two manganese cells connected in series=3.0 V). Consequently, at next step S6, the methanol reserved in the fuel cartridge 10 is supplied toward the power generating device 31. As a result, the power generating device 31 starts electric power generation at step S7.

Whether or not electric power generation by the power generating device 31 is started is decided at step S8 depending upon whether or not the voltage detecting sensor 35 connected to the control device 32 detects a generated voltage. In particular, if the power generating device 31 starts power generation, then the electric power is supplied to the control device 32. Then, since the voltage of the control device 32 is detected by the voltage detecting sensor 35, if the voltage becomes higher than a predetermined voltage (higher than 3.0 V which is a voltage of the primary cell 13), then it is decided that electric power generation is started.

Therefore, if a generated voltage is not detected at step S8 (if the detected voltage of the voltage detecting sensor 35 is lower than the predetermined voltage), the processing returns to step S5 so that the driving of the fuel supplying pump 33 is continued as it is. In particular, when the voltage detecting sensor 35 does not detect power generation of the power generating device 31, the control device 32 controls so that the fuel supplying pump 33 is driven by the electric power of the primary cell 13 and supplies methanol to the power generating device 31 to continue the power generation.

On the other hand, if a generated voltage is detected at step S8 (if the voltage detecting sensor 35 detects a voltage higher than the predetermined voltage), then the processing advances to next step S9, at which the control device 32 opens the on/off switch 43 into a cut-off state. Consequently, at next step S10, the switching element 41 formed from a field effect transistor (FET) returns to the conducting state. Therefore, part of the electric power generated by the power generating device 31 is accumulated into the auxiliary cell 34 (refer to FIG. 2). Then, the control device 32 controls so that the fuel supplying pump 33 is driven by electric power of the auxiliary cell 34, and the re-starting is completed at step S11.

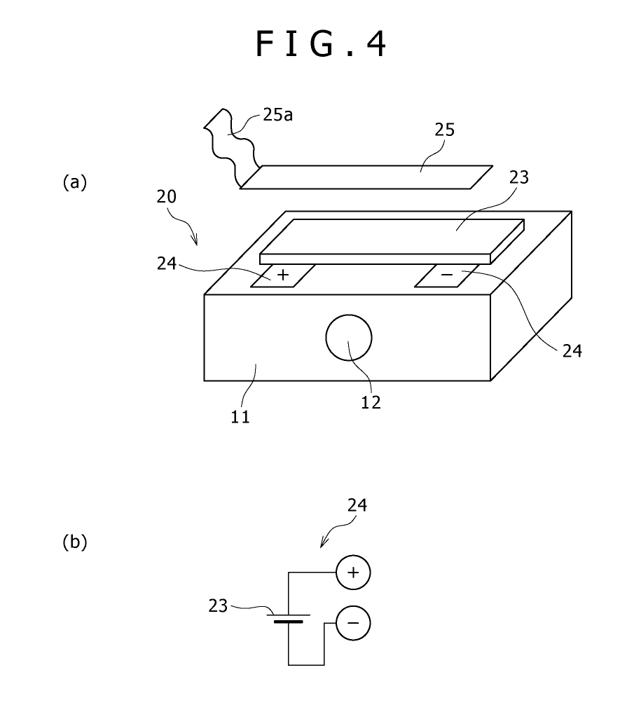

FIG. 4 is a perspective view showing a fuel cartridge 20 of a second embodiment.

As shown in (a) of FIG. 4, the fuel cartridge 20 of the second embodiment has a fuel container section 11 and a fuel supplying port 12 similar to those of the fuel cartridge 10 of the first embodiment shown in (a) of FIG. 1. In particular, the outer profile of the fuel container section 11 is formed in a parallelepiped removably mounted on the fuel cell body 30 (refer to FIG. 2). Further, methanol which is liquid fuel is reserved in the inside of the fuel container section 11. And, the fuel supplying port 12 is formed on one side face of the fuel container section 11. It is to be noted that an on-off valve for preventing leaking out of methanol is provided inside the fuel supplying port 12.

Meanwhile, a primary cell 23 for supplying electric power for starting power generation is a manganese dioxide lithium cell in the form of a plate. And, this primary cell 23 is disposed on a top face of the fuel container section 11. It is to be noted that, since a manganese dioxide lithium cell has high electromotive force (electromotive force=approximately 3.0 V), there is no necessity to connect two cells in series, different from a button-type manganese cell (primary cell 13 shown in FIG. 1). Therefore, since power generation can be started only by the single primary cell 23 without adding such an element as a voltage boosting circuit as shown in (b) of FIG. 4, an electrode configuration section 24 has a simplified circuit configuration and can be suppressed in cost.

Further, the electrode configuration section 24 (+ and −) is disposed on a top face of the fuel container section 11 together with the electrodes of the primary cell 23. And, a seal member 25 for preventing short-circuiting of the primary cell 23 is pasted in such a manner as to cover the electrode configuration section 24 (+ and −). Therefore, if the fuel cartridge 20 is new, then not only sufficient methanol is reserved in the fuel container section 11 but also the primary cell 23 has sufficient electric power to start power generation of the fuel cell body 30 (refer to FIG. 2). It is to be noted that the seal member 25 is peeled off using a knob portion 25a thereof when the fuel cartridge 20 is to be used.

In this manner, with the fuel cell system 100 (refer to FIG. 2) of the present embodiment, even if the auxiliary cell 34 (refer to FIG. 2) is exhausted and the fuel cell system 100 cannot start up by itself, by mounting the fuel cartridge 10 (refer to FIG. 1) of the first embodiment or the fuel cartridge 20 (refer to FIG. 4) of the second embodiment, the fuel cell system 100 can be re-started normally. In particular, the auxiliary cell 34 of the fuel cell system 100 is disconnected, and the fuel supplying pump 33 (refer to FIG. 2) can be driven by the primary cell 13 (refer to FIG. 1) of the fuel cartridge 10 or the primary cell 23 (refer to FIG. 4) of the fuel cartridge 20 to start electric power generation.

Further, the electrode configuration section 14 (refer to FIG. 1) of the primary cell 13 or the electrode configuration section 24 (refer to FIG. 4) of the primary cell 23 is protected by the seal member 15 (refer to FIG. 1) or the seal member 25 (refer to FIG. 4). Therefore, not only short-circuiting of the primary cell 13 (primary cell 23) is prevented and sufficient electric power is maintained, but the safety when the fuel cartridge 10 (fuel cartridge 20) is operated or in a like case is improved.

While the embodiments of the present invention are described above, the present invention is not limited to the embodiments described above but allows such various modifications and so forth. In particular,

(1) while, in the embodiments described above, methanol is used as the fuel for power generation to be used in the fuel cell system 100, the fuel is not limited to methanol but any liquid fuel may be used if it contains hydrogen in composition thereof. In particular, also it is possible to use alcohol-type liquid fuel such as ethanol and butanol and fuel of liquefied carbon hydrides such as dimethyl ether, isobutene and natural gas which have the form of gas under room-temperature normal-pressure conditions.

(2) In the embodiments described above, the fuel cartridge 10 (fuel cartridge 20) has the primary cell 13 (primary cell 23). However, not a primary cell but a secondary battery may be used. And, where a secondary battery is used, if part of electric power generated by the power generating device 31 is accumulated into the secondary battery, then the auxiliary cell 34 can be eliminated from the fuel cell body 30.

1. A fuel cartridge, comprising:
a fuel container section formed for removable mounting on a fuel cell body and having liquid fuel, which is to be supplied to the fuel cell body, reserved therein;
a fuel supplying port for supplying the liquid fuel reserved in said fuel container section to said fuel cell body therethrough;
a cell for supplying electric power for starting power generation of said fuel cell body; and
an electrode configuration section for supplying the electric power of said cell to said fuel cell body.

2. The fuel cartridge according to claim 1, further comprising a short-circuiting preventing member for preventing short-circuiting of said cell.

3. A fuel cell system, comprising:
a fuel cell body for generating electric power using liquid fuel; and
a fuel cartridge formed for removable mounting on said fuel cell body for supplying liquid fuel to said fuel cell body;
said fuel cartridge including
a fuel container section having liquid fuel reserved therein,
a fuel supplying port for supplying the liquid fuel reserved in said fuel container section to said fuel cell body therethrough,
a cell for supplying electric power for starting power generation of said fuel cell body, and
an electrode configuration section for supplying the electric power of said cell to said fuel cell body,
said fuel cell body including
a fuel accepting port corresponding to said fuel supplying port,
an electric contact section corresponding to said electrode configuration section,
a power generating device for starting electric power generation by supply of liquid fuel thereto,
a fuel supplying device for supplying liquid fuel from said fuel accepting port to said power generating device, and
a control device for controlling so that said fuel supplying device is driven by the electric power of said cell.
